(19) United States
(12) Patent Application Publication
(10) Pub. No.: US 2022/0250343 A1
(43) Pub. Date: Aug. 11, 2022

(54) MANUFACTURING METHOD OF CONTACT LENSES

(71) Applicant: VIZIONFOCUS INC., Miaoli County (TW)

(72) Inventors: CHU-YI YU, Miaoli County (TW); YAO-TSUNG CHENG, Miaoli County (TW); WEI-HANG HSU, Miaoli County (TW)

(21) Appl. No.: 17/667,565

(22) Filed: Feb. 9, 2022

(30) Foreign Application Priority Data
Feb. 9, 2021 (TW) 110105080

(51) Int. Cl. B29D 11/00

(52) U.S. Cl. CPC B29D 11/00067; B29K 2083/00

(57) ABSTRACT

A manufacturing method of contact lenses includes a step of: hydrating a lens body. The strep of hydrating the lens body includes steps of: providing the lens body; preparing a hydration solution, wherein the hydration solution is a 5-95 v/v % alcohol ether aqueous solution; soaking the lens body in the hydration solution for at least 30 minutes; and soaking the lens body in water for at least 15 minutes to form a contact lens.

### FIELD OF THE INVENTION

The present invention relates to a manufacture method of contact lenses, and more particularly to a hydration method of contact lenses.

### BACKGROUND OF THE INVENTION

The soft contact lens material has been introduced since the 1960s. Due to the soft material, it solves the uncomfortable feeling of wearing the original rigid gas permeable (RGP) lens. Users who are not used to rigid gas permeable lenses can turn to soft contact lenses, and therefore soft contact lenses are the primary choice for contact lens users today.

However, the conventional used material of soft contact lenses (the main component is HEMA, commonly known as a water glue product) has a low oxygen permeability, and generally Dk (oxygen permeability) is only 8 to 20, which leads to consumers who often have bloodshot eyes and corresponding discomfort problems due to lack of oxygen in the eyes at the end of the day of wearing (wearing for more than 10 hours). Therefore, the main research and development of contact lens materials has turned to seek high oxygen permeability materials. Around 2000, soft contact lens products containing silicone components began to appear on the market, commonly known as silicone hydrogel contact lenses. The oxygen permeability of the silicone hydrogel contact lenses is generally above 40-50 (such as Johnson & Johnson's Acuvue Advanced products), and some products have an oxygen permeability of up to 90. Above (such as Bausch & Lomb's PureVisionDay+Night product). After 2010, daily disposable soft contact lenses began to be accepted by the market due to economic development and consumers' better health concept. Compared with long-term monthly or even annual disposable products, daily-disposable products have significant advantages: they do not need to be took off and replaced every day to clean the lenses, which can avoid eye injuries caused by lens damage caused by cleaning actions; and they can also avoid serious complications such as keratitis and conjunctivitis caused by bacterial infection caused by incomplete cleaning. The promotion of the above daily disposable products not only requires consumers to have a correct concept of eye health, but also requires soft contact lens manufacturers to have excellent production management and advanced technology capabilities to increase production efficiency and reduce production costs to meet the price of daily disposable products, otherwise consumers cannot afford to use daily disposable products. Compared with hydrogel contact lenses, daily-disposable silicone hydrogel contact lenses have more production and process challenges. In addition to the expensive material components of silicone hydrogel contact lenses, it is also necessary to deal with the instability caused by the combination of silicone components and traditional hydrogel components.

The generally known simplest hydration method in the production process of silicone hydrogel contact lenses is water process. The advantage of the water process is that the consumable in the production process is water, and the cost of raw materials is low. However, the water process usually takes a long time to clean the semi-finished lens of the silicone hydrogel contact lens (usually more than 12 hours or even 24 hours). Therefore, although the cost of raw materials is low, the production cost is increased due to the time-consuming and low efficiency of producing lenses. The use of water processes for cleaning and hydration presents another troubling problem. Due to the presence of both silicone components (such as TRIS or other silicone-containing components) and traditional hydrogel components (such as HEMA, NVP, DMA, etc.) in the silicone hydrogel material and the mutual solubility of these two components is poor, internal stress often occurs during contact lens curing (monomers undergo a free radical chain reaction to form a solid polymer). When hydrating with water, this stress often causes uneven hydration expansion, which further causes the lens to have out-of-roundness or deformation.

A further way of hydration is to introduce an organic solvent of alcohol, such as alcohol (ethanol) or isopropanol. The use of such organic solvents to assist hydration can improve the long time required for hydration with only water, and generally shorten the hydration time to 3-4 hours. Because alcohol or isopropyl alcohol can increase the expansion rate and expansion speed of the contact lens when it is hydrated, it helps to relieve the stress of the semi-finished lens after curing, and avoid the out-of-roundness or deformation of the lens after hydration. However, using alcohol or isopropyl alcohol also creates two problems. The first problem is that the concentration of alcohol or isopropyl alcohol must reach 50-75% in order to effectively hydrate the silicone hydrogel lens. At such a concentration, the expansion rate of the silicone hydrogel lens will exceed 1.6 times, and the lens will be easily damaged, resulting in loss of yield during the production process. The second problem is the environmental hazard associated with the use of large quantities of alcohol or isopropyl alcohol on the production site. The flash points of alcohol and isopropyl alcohol are both lower than 20 degrees, which makes the factory management more difficult to strictly prevent the risk of explosion. In order to strictly prevent the risk of explosion, explosion-proof walls, automatic detection and fire-extinguishing equipment must be installed in the production site. The semi-finished products in the production process must be scrapped to avoid product contamination once the fire-fighting action is started. These investment and management costs further drive up production costs, thereby hindering the launch of daily-disposable silicone hydrogel contact lenses.

### SUMMARY OF THE INVENTION

The present invention provides a manufacture method of contact lenses, which can improve the above-mentioned long-time water process, the risk of out-of-roundness and deformation of a product, and avoid the safety problem of product fragmentation and explosion derived from alcohol or isopropanol hydration process.

The manufacturing method of contact lenses provided by the present invention includes a step of: hydrating a lens body. The step of hydrating the lens body includes steps of: providing the lens body; preparing a hydration solution, wherein the hydration solution is a 5-95 v/v % alcohol ether aqueous solution; soaking the lens body in the hydration solution for at least 30 minutes; and soaking the lens body in water for at least 15 minutes to form a contact lens.

In an embodiment of the present invention, the step of soaking the lens body in water for at least 15 minutes further includes: washing the lens body with water.

In an embodiment of the present invention, the step of soaking the lens body in the hydration solution for at least 30 minutes further includes: soaking the lens body a plurality of times in units of 1 hour.

In an embodiment of the present invention, the step of soaking the lens body in water for at least 15 minutes further includes: washing the lens body a plurality of times in units of 1 hour.

In an embodiment of the present invention, the hydration solution is at room temperature, and the temperature of the water is between room temperature and 60° C.

In an embodiment of the present invention, the step of soaking the lens body in water further includes: washing the lens body a plurality of times with water at a variable temperature in an alternating cold and hot manner.

In an embodiment of the present invention, the hydration solution is a 15-80 v/v % alcohol ether aqueous solution.

In an embodiment of the present invention, the alcohol ether of the hydration solution includes: ethylene glycol ether (Ethyl Cellosolve), ethylene glycol propyl ether (2-Propoxyethanol), ethylene glycol butyl ether (Ethylene Glycol Monobutyl Ether), ethylene glycol hexyl ether (Hexyl Cellosolve), glycol phenyl ether (Ethylene Glycol Monophenyl Ether), propylene glycol methyl ether (Propylene Glycol Monomethyl Ether), Propylene Glycol Phenyl Ether, diethylene glycol methyl ether (2-(2-Methoxyethoxy)ethanol), diethylene glycol ether (2-(2-Ethoxyethoxy)ethanol), diethylene glycol butyl ether (Diethylene Glycol Monobutyl Ether), Diethylene Glycol Hexyl Ether, dipropylene glycol methyl ether (Dipropylene Glycol Monomethyl Ether), Dipropylene Glycol Propyl Ether, or dipropylene glycol butyl ether (Dipropylene Glycol n-Butyl Ether).

The present invention uses the alcohol ether aqueous solution as the hydration solution, so it is helpful to shorten the time to reach the expected expansion rate and reduce the incidence of out-of-roundness and deformation of the lens. In addition, alcohol ethers are more stable than alcohols, so they are relatively safe and also helpful to reduce the cost of plant equipment and production management.

The above and other objects, features, and advantages of the present invention will become more apparent from the description of the preferred embodiments and the accompanying drawing.

### BRIEF DESCRIPTION OF THE DRAWING

FIG. 1 is a schematic flowchart of a method for manufacturing contact lenses according to an embodiment of the present invention.

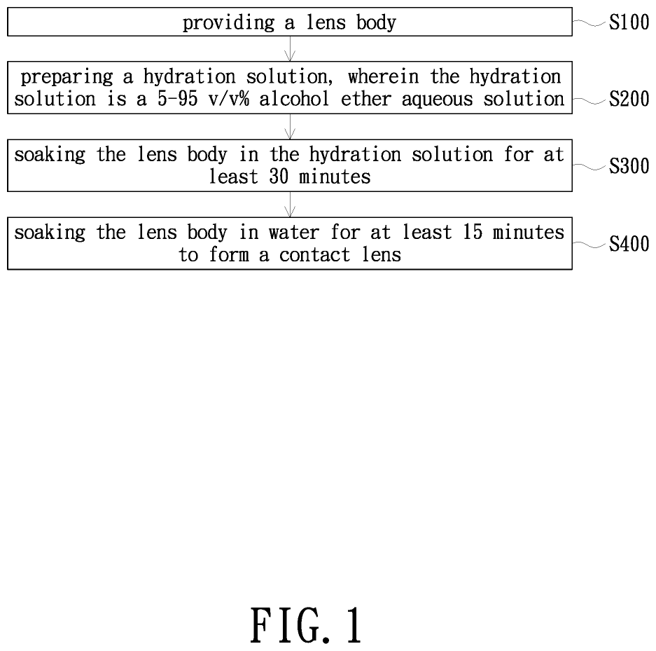

### DETAILED DESCRIPTION OF PREFERRED EMBODIMENTS

In the following description, “unit” is a polymerizable unit compound or chemical structure, which can be divided into monomers or macromers according to the difference in average molecular weight, and can be further divided into hydrophilic and hydrophobic. “Monomer” refers to a compound or chemical structure with an average molecular weight less than 700, and the monomer can be polymerized to form a “polymer”. “Macromolecule” refers to a compound or chemical structure with an average molecular weight greater than 700, and the macromolecules can be polymerized to form a polymer.

“Silicone-containing unit” refers to any repeatable unit compound or chemical structure containing silicone, and the silicone-containing unit includes “silicone-containing monomer” and “silicone-containing macromolecule”. “Silicone-free unit” refers to any repeatable compound or chemical structure that does not contain silicone, and can be divided into hydrophilic and hydrophobic according to the difference in polarity, and can be further divided into “silicone-free monomer” and “silicone-free macromolecule” according to the difference in molecular weight. However, silicone is generally bonded to oxygen and then bound to the hydrogel material, and therefore silicone-containing refers to the chemical structure containing silicon-oxygen bonding (—Si—O—) in the following description.

“Silicone-containing monomer” refers to any unit compound or chemical structure with at least one —Si—O—, with an average molecular weight less than 700 and polymerizable (such as 3-[Tris(trimethylsiloxy)silyl]propyl methacrylate (TRIS) containing at least one non-repeating —Si—O— or polydimethylsiloxane (PDMS) containing at least two repeating —Si—O— and with an average molecular weight less than 700). Other silicone-containing monomers are, for example: 2-(Trimethylsilyloxy)ethyl methacrylate, 3-(3-Methacryloxy-2-hydroxypropoxy)propylbis(trimethyl siloxy)methyl sil ane (SiGMMA), Methacryloxymethyl)bis(trimethylsiloxy)methylsilane, Methacryloxymethylphenethyltris(trimethylsiloxy)silane, Monomethacryloxypropyl terminated polydimethylsiloxane, and Methacryloxypropyl terminated polydimethylsiloxane. Please refer to US patents U.S. Pat. Nos. 7,901,073 and 8,420,711 for other options.

“Silicone-containing macromolecule” refers to any unit compound or chemical structure with at least two repeating —Si—O—, with an average molecular weight greater than 700 and polymerizable (such as PDMS containing at least two repeating —Si—O— and with an average molecular weight greater than 700). Other silicone-containing macromolecule are, for example: Monomethacryloxypropyl terminated polydimethylsiloxane (mPDMS), Methacryloxypropyl terminated polydimethylsiloxane), etc. Please refer to US patents U.S. Pat. No. 7,901,073 and U.S. Pat. No. 8,420,711 for other options.

“Silicone-free unit” refers to a repeatable unit compound or chemical structure that does not contain silicone, and can be divided into hydrophilic and hydrophobic according to its chemical properties. Because the present invention only uses silicone-free unit compounds with an average molecular weight of less than 700, the following only uses the “silicone-free monomer” for the related definition in the present invention.

“Silicone-free monomer” refers to any unit compound or chemical structure that does not contain silicone and with an average molecular weight less than 700, and includes a hydrophilic silicone-free monomer and a hydrophobic silicone-free monomer. Hydrophilic silicone-free monomer are, for example: N-vinyl pyrrolidone (NVP), N-Methyl-N-vinylacetamide (MVA), N,N-Dimethylacrylamide (DMA), N,N-Diethylacrylamide, N-(Hydroxymethyl)acrylamide, N-Hydroxyethyl acrylamide, 2-Hydroxyethyl methacrylate (HEMA), Hydroxypropyl methacrylate and/or Hydroxyisopropyl methacrylate, Hydroxybutyl methacrylate (HOBMA), Poly(propylene ethylene glycol) methacrylate, Poly(ethpropylene glycol) acrylate, Glyceryl methacrylate, Glycidyl methacrylate, 2-Hydroxyethyl acrylate (HEA), Hydroxypropyl acrylate and/or Hydroxyisopropyl acrylate, 4-Hydroxybutyl acrylate, Glyceryl acrylate etc. The hydrophobic silicone-free monomers are, for example: Lauryl methacrylate, Methyl methacrylate (MMA), Ethyl methacrylate, Propyl methacrylate, Isopropyl methacrylate, Butyl methacrylate, Hexyl methacrylate, 2-Ethylhexyl methacrylate, Stearyl methacrylate or Octadecyl methacrylate, Isodecyl methacrylate, Isobornyl methacrylate, Ethyl acrylate, Propyl acrylate, Isopropyl acrylate, Butyl acrylate, 2-Ethylhexyl acrylate, Stearyl acrylate or Octadecyl acrylate, Isodecyl acrylate, Lauryl acrylate etc.

In the following description, “room temperature” generally refers to the temperature ranged 20° C. to 30° C., and precisely ranged 23° C. to 27° C.

The weight percentage of the silicone-containing unit in the composition is between 6 and 80 wt %, and preferably between 14 and 65 wt %. The silicone-containing unit may include silicone-containing monomer and silicone-containing macromolecule. For example, some embodiments of the present invention use silicone-containing monomer TRIS, wherein TRIS accounts for 5-75 wt % of the composition, preferably accounts for 10-60 wt % of the composition, and more preferably accounts for 15-45 wt % of the composition. Some embodiments of the present invention use silicone-containing macromolecule mPDMS, wherein mPDMS accounts for 1-45 wt % of the composition, preferably accounts for 1-25 wt % of the composition, and more preferably accounts for 6-15 wt % of the composition.

The weight percentage of the silicone-free unit in the composition is between 15 and 86 wt %, preferably between 18 and 61 wt %, and more preferably between 25 and 56 wt %. The weight percentage of hydrophilic silicone-free monomers in the composition is greater than that of hydrophobic silicone-free monomers in the composition.

In some embodiments of the present invention, the hydrophilic silicone-free monomer accounts for 5-85 wt % of the composition, preferably 10-60 wt % of the composition, and more preferably 20-55 wt % of the composition. Preferred hydrophilic silicone-free monomers used include, but are not limited to, NVP, MVA, DMA, N,N-Diethylacrylamide, N-(Hydroxymethyl)acrylamide, and N-Hydroxyethyl acrylamide.

The hydrophobic silicone-free monomer in the silicone-free unit is mainly used to adjust the mechanical properties of the contact lens. In some embodiments of the present invention, the hydrophobic silicone-free monomer accounts for 0.1-10 wt % of the composition, preferably 0.5-7.5 wt % of the composition, and the more preferably 1-5 wt % of the composition. Preferred hydrophobic silicone-free monomers used include, but are not limited to, lauryl methacrylate and MMA.

The cross-linking agent is used to make the monomers carry out the polymerization reaction smoothly, so that the produced polymer has the required cross-linking density, and can also make the two polymer chains react and bond form a network polymer. Because any polymerization reaction can be selected to add a suitable cross-linking agent, the cross-linking agent can be selectively added at the beginning of any polymerization reaction. In some embodiments of the present invention, the cross-linking agent accounts for 0.1-3 wt % of the composition, preferably 0.3-2 wt % of the composition, and more preferably 0.5-1.5 wt % of the composition. Preferred cross-linking agents in the embodiments of the present invention include but are not limited to: 2-isocyanatoethyl methacrylate (IEM) and Ethylene glycol dimethacrylate (EGDMA). Other selected cross-linking agents are, for example: Di(ethylene glycol) dimethacrylate, Triethylene glycol dimethacrylate, Tetraethylene glycol dimethacrylate, Ethylene glycol diacrylate, Di(ethylene glycol) diacrylate, Triethylene glycol diacrylate, Tetraethylene glycol diacrylate, N,N′-Methylenebis(acrylamide), N,N′-Ethylenebis(acrylamide), N,N′-(1,2-Dihydroxyethylene)bisacrylamide, Trimethylolpropanetrimethacrylate, N,N′-Hexamethylenebis (methacrylamide), Glycerol trimethacrylate, Polyethylene glycol dimethacrylate, Polyethylene glycol diacrylate, Vinyl methacrylate, Allyl methacrylate, Methacryloyl chloride, Glycidyl acrylate, 3-Chloro-2-hydroxypropyl methacrylate, mono-2-(Methacryloyloxy)ethyl maleate, Diurethanedimethacrylate, 3-Isop ropenyl-α,α-dimethylbenzylisocyanate), etc., which can be selected and used according to different reactants and needs.

“Initiators” can be divided into thermal initiators and photo initiators according to the different ways of initiating the reaction. The initiator is a compound used to initiate depolymerization, cross-linking and curing of units and also has a decisive effect on curing the composition thereby enabling the composition to have better dimensional stability during molding, so the initiator can be selectively added at the beginning of any polymerization reaction. The thermal initiator used in some embodiments of the present invention is Azobisisobutyronitrile (AIBN). The thermal initiators used in other embodiments are, for example: 4,4′-Azobis(4-cyanovaleric acid), 1,1′-Azobis(cyclohexanecarbonitrile), 2,2′-Azobis(2-methylpropionamidine), (2,2′-Azobis(2-methylpropionamidine)dihydrochloride), 2,2′-Azobis [2-(2-imidazolin-2-yl)propane]dihydrochloride, 2,2′-Azobis {2-[1-(2-hydroxyethyl)-2-imidazolin-2-yl]propane}dihydrochlo ride, 2,2′-Azobis(1-imino-1-pyrrolidino-2-ethylpropane)dihydrochloride, 2,2′-Azobis {2-methyl-N-[1,1-bis(hydroxymethyl)-2-hydroxyethyl]propionamide}, 2,2′-Azobis [2-methyl-N-(2-hydroxyethyl)propionamide], 2,2′-Azobis(4-methoxy-2,4-dimethyl valeronitrile, Benzoyl peroxide, etc. The photo initiators used in some embodiments of the present invention are, for example: Irgacure®1173 2-Hydroxy-2-methylpropiophenone and Phenylbis(2,4,6-trimethylbenzoyl)phosphine oxide (BAPOs). The photo initiators used in other embodiments are: Diphenyl(2,4,6-trimethylbenzoyl) phosphine oxide, 2,2-Dimethoxy-2-phenylacetophenone, etc.

In some embodiments of the present invention, the initiator accounts for 0.01-4 wt % of the composition, preferably 0.1-1.8 wt % of the composition, and more preferably 0.3-1.2 wt % of the composition.

The present invention provides a manufacturing method of contact lenses, which includes: hydrating a lens body (i.e., a dry lens), wherein the lens body is composed of a silicone-containing unit, a silicone-free unit, or a combination of a silicone unit and a silicone-free unit. The preparation of the lens body includes: providing a composition including a silicone-containing unit, a silicone-free unit, a cross-linking agent and an initiator and performing polymerization, cross-linking and curing of the aforementioned units to form the lens body. The lens body can be prepared by conventional techniques, and no redundant detail is to be given herein.

In an embodiment of the present invention, the step of hydrating the lens body includes steps of: providing the lens body (S100); preparing a hydration solution (S200), wherein the hydration solution is a 5-95 v/v % alcohol ether aqueous solution; soaking the lens body in the hydration solution for at least 30 minutes (S300); and soaking the lens body in water for at least 15 minutes to form a contact lens (S400).

That is, the hydration of the lens body includes two parts: the first part and the second part. Specifically, the first part uses a mixture of alcohol ether solvent and water to soak the lens body. The soaking temperature may be room temperature. The use of the alcohol ether aqueous solution as the hydration solution can effectively reduce the percentage of defects related to out-of-roundness (including deformation, out-of-roundness and sticky problem) caused by the conventional lens body hydration. Further, the hydration of the first part can help relieve the stress of the lens body from dry to wet and allow the lens to achieve a specific expansion rate. The soaking time ranges from, for example, half an hour to 12 hours, and all have corresponding different degrees of stress release effect, which can significantly reduce the probability of occurrence of defects related to the out-of-roundness of the lens. The expansion rate can be known by measuring the change in the diameter of the lens with a ruler. In the embodiment of the present invention, the diameter can be increased to 13-19 mm when the lens body is hydrated from a dry lens to a wet lens.

The alcohol ethers include: Ethyl Cellosolve (ECS), 2-Propoxyethanol (PCS), Ethylene Glycol Monobutyl Ether (BCS), Hexyl Cellosolve (HCS), Ethylene Glycol Monophenyl Ether (EPH), Propylene Glycol Monomethyl Ether (PM), Propylene Glycol Phenyl Ether (PPH), 2-(2-Methoxyethoxy)ethanol (DM), 2-(2-Ethoxyethoxy)ethanol (DE), Diethylene Glycol Monobutyl Ether (DB), Diethylene Glycol Hexyl Ether (Hexyl Carbitol), Dipropylene Glycol Monomethyl Ether, Dipropylene Glycol Propyl Ether (DPnP), and Dipropylene Glycol n-Butyl Ether (DPnB), which can be used alone or selected from a combination thereof. The alcohol ether accounts for 5-95 v/v % of the hydration solution, and preferably 15-80 v/v % of the hydration solution. In general, the larger the ratio of alcohol ether, the higher the expansion ratio. The determination of the alcohol ether ratio can be considered together with the desired expansion ratio, the type of alcohol ether, and the units constituting the lens body.

The second part follows the first part and uses water. That is, after being soaked in the alcohol ether aqueous solution, the lens body is soaked in water instead to wash off the alcohol ether and replace the alcohol ether in the lens body with water. The time for soaking the lens body in water is preferably at least 15-30 minutes to ensure the occurrence of cleaning and replacement. The soaking temperature can be a constant temperature or a variable temperature in an alternating cold and hot manner. For example, the lens body can be soaked by a fixed temperature from room temperature to 60° C., or the lens body can be alternately soaked by higher and lower temperatures, wherein the aforementioned temperature range will not have an undue effect on the material of the lens body. Through the thermal expansion and contraction of the lens body caused by the change of temperature, the washing out of the alcohol ether can be promoted. The selection of temperature and whether it is carried out at constant temperature or variable temperature can be determined according to the type of alcohol ether.

Preferably, the amount of water used in the second part is adjusted proportionally according to the number of lens bodies to be processed. For example, if per lens body requires 5-100 mL of water, then 500 mL to 10 L of water will be used when 100 lens bodies are cleaned at one time. The more water used, the fewer cleaning times, and vice versa. The alcohol ether residue of the lens body can be examined by any conventional method during or after the second part. The soaking can be performed a plurality of times in the second part, such as soaking again after changing the water. Preferably, the second part includes at least one water change and two soakings. The number of soakings can be adjusted according to the type of alcohol ether and the residual situation of alcohol ether. For example, the amount of glycol ether measured from the water after soaking is preferably less than 1 ppm. The water may need change for soaking when the measured amount of glycol ether is much higher than 1 ppm.

The soaking and hydration in the second part can further change the expansion rate of the wet lens in the first part. That is, after the hydration in the second part, the diameter of the lens body changes again and reaches the preset diameter of the contact lens. The following Embodiments 1-3 further illustrates the conditions and results of lens body hydration.

### Embodiment 1

Step S100: providing a lens body. The lens bodies of this embodiment are respectively prepared from ten compositions with different formulations. There are differences in the content of silicone-containing units, the content of silicone-free units, the type of silicone-containing units, and the type of silicone-free units between different formulations. For example, the silicone-containing unit is TRIS, mPDMS, DMS-R11 (Methacryloxypropyl Terminated PDMS), or a combination selected from them. The silicone-free hydrophilic unit is HEMA, MOEMA (Ethylene glycol methyl ether methacrylate), EOEMA ((2-Ethoxyethyl) methacrylate), NVP, MOMBR (Bromomethyl methyl ether), DMA, BVE (Butyl vinyl ether), EGVE (2-(Vinyloxy)ethanol), DEGVE (Diethyleneglycol monovinylether), or a combination selected from them. The silicone-free hydrophobic unit is MMA, IMB, or a combination selected from them. The formulation also includes a cross-linking agent and an initiator. The cross-linking agent is EGDMA, TEGDMA, PEGDMA, TEGDVE (Tri(ethylene glycol)divinyl ether), or a combination selected from them. The initiator is Irgacure®819 (Bis(2,4,6-trimethylbenzoyl)phenylphosphine oxide), Omnirad1173, or a combination selected from them. The formulation can further include ultraviolet absorbers, chain transfer agents, solubilizers, terminators, etc. In the embodiment of the present invention, the ultraviolet absorber can be, for example, HMEPB, BHPEA; the chain transfer agent can be, for example, 1-Decanethiol, 2-Allyloxyethanol; the solubilizer can be, for example, lactic acid, TPME; and the terminator can be, for example, MEHQ (Monomethyl ether hydroquinone), 2-Ethoxyphenol.

Step S200: preparing a hydration solution. The hydration solution (hydration solution 1) in this embodiment is a complete mixture of 50 v/v % ethylene glycol propyl ether and 50 v/v % water. In this embodiment, a first tank of hydration solution and a second tank of hydration solution are prepared for use.

Step S300: soaking the lens body in the hydration solution for at least 30 minutes. In this embodiment, the lens body is left standing and soaked in the first tank of hydration solution 1 for 1 hour, and then soaked in the second tank of hydration solution 1 for 1 hour, that is, the there are 2 hours for the first part of the treatment. The lens body can also be soaked in the same tank of hydration solution for a sufficient time without changing the tank. The soaking temperature is room temperature.

Step S400: soaking the lens body in water for at least 15 minutes to form a contact lens. In this embodiment, four water tanks are prepared, and the lens body is soaked in the four water tanks in sequence for 1 hour. The soaking may also be performed with stirring. The soaking time and the number of tank changes can also be increased or decreased in this step. The more times the tank is changed, the shorter the total soaking time should be. For example, this step can be changed to soak the lens body in five water tanks in sequence for half an hour. The soaking temperature is room temperature.

Through observation, measurement or calculation, the contact lenses manufactured in this embodiment rarely have fragments or out-of-roundness, wherein lenses with fragment or out-of-roundness are considered bad lenses. The results are shown in Table 1, which indicates that the contact lenses manufactured in Embodiment 1 have a low defective rate.

TABLE 1

| | Formula | | | | | | | | | |
|---|---|---|---|---|---|---|---|---|---|---|
| | 1 | 2 | 3 | 4 | 5 | 6 | 7 | 8 | 9 | 10 |
| Total number | 500 | 500 | 500 | 500 | 500 | 500 | 500 | 500 | 500 | 500 |
| of experiments | | | | | | | | | | |
| Number of | 0 | 0 | 0 | 1 | 0 | 0 | 0 | 0 | 1 | 0 |
| fragments | | | | | | | | | | |
| Number of | 0 | 1 | 0 | 0 | 2 | 0 | 1 | 0 | 0 | 0 |
| out-of-roundness | | | | | | | | | | |
| Defective rate | 0.0% | 0.2% | 0.0% | 0.2% | 0.4% | 0.0% | 0.2% | 0.0% | 0.2% | 0.0% |

The basis for judging as a “fragment” is, for example, a crack or a break in the contact lens, and the crack or the break reaches 1 mm “Out-of-roundness” can be determined by measuring a plurality of diameters of the lens, for example, comparing two diameters measured in the vertical direction.

### Embodiment 2

Step S100: providing a lens body. The lens body in this embodiment is the same as that used in Embodiment 1.

Step S200: preparing a hydration solution. The hydration solution (hydration solution 2) in this embodiment is a complete mixture of 35 v/v % propylene glycol methyl ether and 65 v/v % water. In this embodiment, six tanks of hydration solution are prepared for use.

Step S300: soaking the lens body in the hydration solution for at least 30 minutes. In this embodiment, the lens body is soaked in the six tanks of hydration solution 2 in sequence for 1 hour, that is, there are 6 hours for the first part of the treatment. The lens body can also be soaked in the same tank of hydration solution for a sufficient time without changing the tank. The soaking temperature is room temperature.

Step S400: soaking the lens body in water for at least 15 minutes to form a contact lens. In this embodiment, six water tanks are prepared, and the lens body is soaked in the six water tanks in sequence for 1 hour. The soaking temperature is a constant temperature of 60° C. The soaking time and the number of tank changes can also be increased or decreased and the soaking temperature can be reduced in this step.

Through observation, measurement or calculation, the contact lenses manufactured in this embodiment rarely have fragments or out-of-roundness, wherein lenses with fragment or out-of-roundness are considered bad lenses. The results are shown in Table 2, which indicates that the contact lenses manufactured in Embodiment 2 have a low defective rate.

TABLE 2

| | Formula | | | | | | | | | |
|---|---|---|---|---|---|---|---|---|---|---|
| | 1 | 2 | 3 | 4 | 5 | 6 | 7 | 8 | 9 | 10 |
| Total number of | 500 | 500 | 500 | 500 | 500 | 500 | 500 | 500 | 500 | 500 |
| experiments | | | | | | | | | | |
| Number of | 1 | 0 | 1 | 0 | 0 | 1 | 0 | 0 | 0 | 0 |
| fragments | | | | | | | | | | |
| Number of | 0 | 0 | 0 | 1 | 0 | 0 | 0 | 1 | 0 | 0 |
| out-of-roundness | | | | | | | | | | |
| Defective rate | 0.2% | 0.0% | 0.2% | 0.2% | 0.0% | 0.2% | 0.0% | 0.2% | 0.0% | 0.0% |

### Embodiment 3

Step S100: providing a lens body. The lens body in this embodiment is the same as that used in Embodiment 1.

Step S200: preparing a hydration solution. The hydration solution (hydration solution 3) in this embodiment is a complete mixture of 65 v/v % dipropylene glycol butyl ether and 35 v/v % water. In this embodiment, two tanks of hydration solution are prepared for use.

Step S300: soaking the lens body in the hydration solution for at least 30 minutes. In this embodiment, the lens body is soaked in the two tanks of hydration solution 3 in sequence for 1 hour, that is, the there are 2 hours for the first part of the treatment. The lens body can also be soaked in the same tank of hydration solution for a sufficient time without changing the tank. The soaking temperature is room temperature.

Step S400: soaking the lens body in water for at least 15 minutes to form a contact lens. In this embodiment, six water tanks are prepared, wherein three water tanks have room temperature, and the rest three water tanks have a temperature of 60° C. The lens body is first soaked in a room temperature water tank for 1 hour, and then soaked in a 60° C. constant temperature water tank for 1 hour. The soaking in an alternating cold and hot manner repeats three times.

Through observation, measurement or calculation, the contact lenses manufactured in this embodiment rarely have fragments or out-of-roundness, wherein lenses with fragment or out-of-roundness are considered bad lenses. The results are shown in Table 3, which indicates that the contact lenses manufactured in Embodiment 3 have a low defective rate.

TABLE 3

| | Formula | | | | | | | | | |
|---|---|---|---|---|---|---|---|---|---|---|
| | 1 | 2 | 3 | 4 | 5 | 6 | 7 | 8 | 9 | 10 |
| Total number of | 500 | 500 | 500 | 500 | 500 | 500 | 500 | 500 | 500 | 500 |
| experiments | | | | | | | | | | |
| Number of | 1 | 0 | 1 | 1 | 0 | 0 | 1 | 0 | 1 | 0 |
| fragments | | | | | | | | | | |
| Number of | 0 | 0 | 0 | 0 | 0 | 0 | 0 | 1 | 0 | 2 |
| out-of-roundness | | | | | | | | | | |
| Defective rate | 0.2% | 0.0% | 0.2% | 0.2% | 0.0% | 0.0% | 0.2% | 0.2% | 0.2% | 0.4% |

### Embodiment 4

Step S100: providing a lens body. The lens body in this embodiment is the same as that used in Embodiment 1.

Step S200: preparing a hydration solution. The hydration solution (hydration solution 4) in this embodiment is a complete mixture of 5 v/v % propylene glycol phenyl ether and 95 v/v % water. In this embodiment, two tanks of hydration solution are prepared for use.

Step S300: soaking the lens body in the hydration solution for at least 30 minutes. In this embodiment, the lens body is soaked in the two tanks of hydration solution 4 in sequence for 1 hour, that is, the there are 2 hours for the first part of the treatment. The lens body can also be soaked in the same tank of hydration solution for a sufficient time without changing the tank. The soaking temperature is room temperature.

Step S400: soaking the lens body in water for at least 15 minutes to form a contact lens. In this embodiment, three water tanks are prepared, and the lens body is soaked in the three water tanks in sequence for 1 hour. The soaking temperature is room temperature.

Through observation, measurement or calculation, the contact lenses manufactured in this embodiment rarely have fragments or out-of-roundness, wherein lenses with fragment or out-of-roundness are considered bad lenses. The results are shown in Table 4, which indicates that the defective rate of the contact lenses manufactured in Embodiment 4 is not high.

TABLE 4

| | Formula | | | | | | | | | |
|---|---|---|---|---|---|---|---|---|---|---|
| | 1 | 2 | 3 | 4 | 5 | 6 | 7 | 8 | 9 | 10 |
| Total number of | 500 | 500 | 500 | 500 | 500 | 500 | 500 | 500 | 500 | 500 |
| experiments | | | | | | | | | | |
| Number of | 1 | 0 | 0 | 3 | 0 | 1 | 0 | 2 | 1 | 0 |
| fragments | | | | | | | | | | |
| Number of | 5 | 7 | 2 | 5 | 9 | 1 | 2 | 1 | 11 | 12 |
| out-of-roundness | | | | | | | | | | |
| Defective rate | 1.20% | 1.40% | 0.40% | 1.60% | 1.80% | 0.40% | 0.40% | 0.60% | 2.40% | 2.40% |

### Embodiment 5

Step S100: providing a lens body. The lens body in this embodiment is the same as that used in Embodiment 1.

Step S200: preparing a hydration solution. The hydration solution (hydration solution 5) in this embodiment is a complete mixture of 95 v/v % diethylene glycol methyl ether and 5 v/v % water. In this embodiment, two tanks of hydration solution are prepared for use.

Step S300: soaking the lens body in the hydration solution for at least 30 minutes. In this embodiment, the lens body is soaked in the two tanks of hydration solution 5 in sequence for 1 hour, that is, the there are 2 hours for the first part of the treatment. The lens body can also be soaked in the same tank of hydration solution for a sufficient time without changing the tank. The soaking temperature is room temperature.

Step S400: soaking the lens body in water for at least 15 minutes to form a contact lens. In this embodiment, six water tanks are prepared, and the lens body is soaked in the six water tanks in sequence for 1 hour. The soaking temperature is room temperature.

Through observation, measurement or calculation, the contact lenses manufactured in this embodiment rarely have fragments or out-of-roundness, wherein lenses with fragment or out-of-roundness are considered bad lenses. The results are shown in Table 5, which indicates that the defective rate of the contact lenses manufactured in Embodiment 5 is not high.

TABLE 5

| | Formula | | | | | | | | | |
|---|---|---|---|---|---|---|---|---|---|---|
| | 1 | 2 | 3 | 4 | 5 | 6 | 7 | 8 | 9 | 10 |
| Total number of | 500 | 500 | 500 | 500 | 500 | 500 | 500 | 500 | 500 | 500 |
| experiments | | | | | | | | | | |
| Number of | 1 | 0 | 0 | 3 | 0 | 1 | 0 | 2 | 1 | 0 |
| fragments | | | | | | | | | | |
| Number of | 0 | 1 | 0 | 0 | 0 | 0 | 2 | 0 | 0 | 0 |
| out-of-roundness | | | | | | | | | | |
| Defective rate | 0.20% | 0.20% | 0.00% | 0.60% | 0.00% | 0.20% | 0.40% | 0.40% | 0.20% | 0.00% |

The following are control groups 1 and 2.

Control group 1:

The lens body used in the control group 1 is the same as that in Embodiments 1-3, except that 50 v/v % isopropyl alcohol aqueous solution and water are used for hydration. First, the lens body is soaked in a 50 v/v % isopropyl alcohol aqueous solution for 1 hour, and then soaked in a 60° C. constant temperature water tank for 1 hour. There are six water tanks in total, and the lens body is soaked in each of the six water tanks for 1 hour. Through observation, measurement or calculation, the fragmentation rate is as high as 35%, and the results are shown in Table 6.

TABLE 6

| | Formula | | | | | | | | | |
|---|---|---|---|---|---|---|---|---|---|---|
| | 1 | 2 | 3 | 4 | 5 | 6 | 7 | 8 | 9 | 10 |
| Total number | 500 | 500 | 500 | 500 | 500 | 500 | 500 | 500 | 500 | 500 |
| of experiments | | | | | | | | | | |
| Number of | 134 | 184 | 201 | 147 | 211 | 207 | 138 | 164 | 185 | 179 |
| fragments | | | | | | | | | | |
| Number of | 0 | 1 | 0 | 1 | 0 | 0 | 0 | 1 | 0 | 2 |
| out-of-roundness | | | | | | | | | | |
| Defective rate | 26.8% | 37.0% | 40.2% | 29.6% | 42.2% | 41.4% | 27.6% | 33.0% | 37.0% | 36.2% |

Control group 2:

The lens body used in the control group 2 is the same as that in Embodiments 1-3, but was directly hydrated with water. First, the lens body is soaked in a room temperature water tank for 1 hour, and then is soaked in a 60° C. constant temperature water tank for 1 hour. There are four room temperature water tanks and four 60° C. constant temperature water tanks. The soaking in an alternating cold and hot manner repeats four times. Through observation, measurement or calculation, the out-of-roundness rate is higher than 90%, and the results are shown in Table 7.

TABLE 7

| | Formula | | | | | | | | | |
|---|---|---|---|---|---|---|---|---|---|---|
| | 1 | 2 | 3 | 4 | 5 | 6 | 7 | 8 | 9 | 10 |
| Total number of | 500 | 500 | 500 | 500 | 500 | 500 | 500 | 500 | 500 | 500 |
| experiments | | | | | | | | | | |
| Number of | 1 | 0 | 1 | 1 | 0 | 0 | 1 | 0 | 1 | 0 |
| fragments | | | | | | | | | | |
| Number of | 430 | 463 | 438 | 455 | 460 | 431 | 452 | 459 | 474 | 432 |
| out-of-roundness | | | | | | | | | | |
| Defective rate | 86.2% | 92.6% | 87.8% | 91.2% | 92.0% | 86.2% | 90.6% | 91.8% | 95.0% | 86.4% |

In summary, the embodiments of the present invention significantly improve the lens fragmentation or out-of-roundness caused by hydration with alcohols or hydration with water alone, and are sufficient to reduce the defective rate to 0.0%. Therefore, the present invention reduces the manufacturing cost of the contact lens and improves the quality thereof, and is helpful for the production and introduction of the contact lens.

The above is only the preferred embodiment of the present invention, and the scope of the present invention is not limited thereto. That is, the simple equivalent change and modifications according to the scope of the present invention and the description of the invention are still within the scope of the invention patent. In addition, any of the objects or advantages or features of the present invention are not required to be achieved by any embodiment or application of the invention. In addition, the Abstract and Title are only used to assist in the search of patent documents and are not intended to limit the scope of the invention. In addition, the terms “first” and “second” as used in the specification or the scope of the patent application are used only to name the elements or to distinguish different embodiments or ranges, and are not intended to limit the upper or lower limit number of elements.

What is claimed is:

1. A manufacturing method of contact lenses, comprising a step of:
hydrating a lens body, comprising steps of:
providing the lens body;
preparing a hydration solution, wherein the hydration solution is a 5-95 v/v % alcohol ether aqueous solution;
soaking the lens body in the hydration solution for at least 30 minutes; and
soaking the lens body in water for at least 15 minutes to form a contact lens.

2. The manufacturing method of contact lenses according to claim 1, wherein the step of soaking the lens body in water for at least 15 minutes further comprises: washing the lens body with water.

3. The manufacturing method of contact lenses according to claim 1, wherein the step of soaking the lens body in the hydration solution for at least 30 minutes further comprises: soaking the lens body a plurality of times in units of 1 hour.

4. The manufacturing method of contact lenses according to claim 2, wherein the step of soaking the lens body in water for at least 15 minutes further comprises: washing the lens body a plurality of times in units of 1 hour.

5. The manufacturing method of contact lenses according to claim 1, wherein the hydration solution is at room temperature, and the temperature of the water is between room temperature and 60° C.

6. The manufacturing method of contact lenses according to claim 1, wherein the step of soaking the lens body in water further comprises: washing the lens body a plurality of times with water at a variable temperature in an alternating cold and hot manner.

7. The manufacturing method of contact lenses according to claim 1, wherein the hydration solution is a 15-80 v/v % alcohol ether aqueous solution.

8. The manufacturing method of contact lenses according to claim 1, wherein the alcohol ether of the hydration solution comprises ethylene glycol ether (Ethyl Cellosolve), ethylene glycol propyl ether (2-Propoxyethanol), ethylene glycol butyl ether (Ethylene Glycol Monobutyl Ether), ethylene glycol hexyl ether (Hexyl Cellosolve), glycol phenyl ether (Ethylene Glycol Monophenyl Ether), propylene glycol methyl ether (Propylene Glycol Monomethyl Ether), Propylene Glycol Phenyl Ether, diethylene glycol methyl ether (2-(2-Methoxyethoxy)ethanol), diethylene glycol ether (2-(2-Ethoxyethoxy)ethanol), diethylene glycol butyl ether (Diethylene Glycol Monobutyl Ether), Diethylene Glycol Hexyl Ether, dipropylene glycol methyl ether (Dipropylene Glycol Monomethyl Ether), Dipropylene Glycol Propyl Ether, or dipropylene glycol butyl ether (Dipropylene Glycol n-Butyl Ether).

9. The manufacturing method of contact lenses according to claim 1, wherein the lens body is composed of a silicone-containing unit and a silicone-free unit, the silicone-containing unit accounts for 6-80 wt % of a composition, the silicone-free unit accounts for 15-86 wt % of the composition, the silicon-free unit comprises hydrophilic silicone-free monomer and hydrophobic silicone-free monomer, and a weight percentage of the hydrophilic silicone-free monomer is greater than a weight percent of the hydrophobic silicone-free monomer.

10. The manufacturing method of contact lenses according to claim 9, wherein the silicone-containing unit is a silicone-containing monomer TRIS or a silicone-containing macromolecule mPDMS, a weight percentage of the TRIS is 5-75 wt %, a weight percentage of the mPDMS is 1-45 wt %, the hydrophilic silicone-free monomer accounts for 5-85 wt % of the composition and is N-vinylpyrrolidone, N-methyl-N-vinylacetate amine, N,N-dimethylacrylamide, N,N-diethylacrylamide, N-methylolacrylamide, N-hydroxyethylacrylamide, or a combination selected from them, and the hydrophobic silicone-free monomer accounts for 0.1-10 wt % of the composition and is lauryl methacrylate, methyl methacrylate, or a combination selected from them.

11. The manufacturing method of contact lenses according to claim 10, wherein the weight percent of the TRIS is 10-60 wt % or the weight percent of the mPDMS is 4-25 wt %, the weight percent of the hydrophilic silicone-free monomer is 10-60 wt %, and the weight percentage of the hydrophobic silicone-free monomer is 0.5-7.5 wt %.

12. The manufacturing method of contact lenses according to claim 11, wherein the weight percent of the TRIS is 15-45 wt % or the weight percent of the mPDMS is 6-15 wt %, the weight percent of the hydrophilic silicone-free monomer is 20-55 wt %, and the weight percentage of the hydrophobic silicone-free monomer is 1-5 wt %.
